(19) United States
(12) Patent Application Publication
(10) Pub. No.: US 2024/0278751 A1
(43) Pub. Date: Aug. 22, 2024

(54) BRAKE COOLING STRUCTURE IN VEHICLE

(71) Applicants: TOYOTA JIDOSHA KABUSHIKI KAISHA, Toyota-shi (JP); SUBARU CORPORATION, Tokyo (JP)

(72) Inventors: Noriaki MATSUO, Okazaki-shi (JP); Tetsuya ICHIYANAGI, Nagoya-shi (JP)

(73) Assignees: TOYOTA JIDOSHA KABUSHIKI KAISHA, Toyota-shi (JP); SUBARU CORPORATION, Tokyo (JP)

(21) Appl. No.: 18/429,952

(22) Filed: Feb. 1, 2024

(30) Foreign Application Priority Data
Feb. 17, 2023 (JP) 2023-023789

(51) Int. Cl. B60T 5/00

(52) U.S. Cl. CPC B60T 5/00

(57) ABSTRACT

A brake cooling structure in a vehicle includes a duct that is provided on a suspension arm provided in the vehicle, and has an introduction opening through which air is taken in from a front side and a discharge opening through which the air is discharged toward a brake rotor that is provided on a wheel connected to the suspension arm through a support member.

### CROSS-REFERENCE TO RELATED APPLICATION

This application claims priority to Japanese Patent Application No. 2023-023789 filed on Feb. 17, 2023, incorporated herein by reference in its entirety.

### BACKGROUND

### 1. Technical Field

The present disclosure relates to a brake cooling structure in a vehicle.

### 2. Description of Related Art

The vehicle disclosed in Japanese Unexamined Patent Application Publication No. 2005-178427 (JP 2005-178427 A) includes a duct provided on a front bumper. When this vehicle travels, travel wind (air) passes through the inside of the duct and is supplied to a brake unit of a front wheel through an air discharge opening of the duct. Thus, the brake unit of the front wheel is cooled by the air supplied thereto.

### SUMMARY

In the above-described vehicle of JP 2005-178427 A, the distance from the air discharge opening of the duct to the brake unit of the front wheel is long. Therefore, it is not easy to cool the brake unit of the front wheel using the air having passed through the duct.

Taking this fact into account, the present disclosure aims to obtain a brake cooling structure in a vehicle that can effectively cool a brake rotor of a wheel using air discharged through a discharge opening of a duct.

A brake cooling structure in a vehicle according to claim 1 includes a duct that is provided on a suspension arm provided in the vehicle, and has an introduction opening through which air is taken in from a front side and a discharge opening through which the air is discharged toward a brake rotor that is provided on a wheel connected to the suspension arm through a support member.

In the brake cooling structure in a vehicle according to claim 1, the duct is provided on the suspension arm that is connected to the wheel through the support member. Thus, the distance from the discharge opening of the duct to the brake rotor provided on the wheel is short. In the brake cooling structure in a vehicle according to claim 1, therefore, the brake rotor of the wheel can be effectively cooled using air discharged through the discharge opening of the duct.

The brake cooling structure according to claim 2 is the brake cooling structure of claim 1, wherein at least part of the introduction opening is located below an under-cover provided in the vehicle.

In the brake cooling structure in a vehicle of claim 2, at least part of the introduction opening is located below the under-cover. Thus, travel wind can be reliably guided to the introduction opening.

The brake cooling structure according to claim 3 is the brake cooling structure of claim 1 or claim 2, wherein the area of the introduction opening is larger than the area of the discharge opening.

In the brake cooling structure in a vehicle of claim 3, the area of the introduction opening is larger than the area of the discharge opening. Thus, travel wind can be easily guided to the introduction opening as well as air can be supplied under high pressure from the discharge opening to the brake rotor.

The brake cooling structure according to claim 4 is the brake cooling structure of claim 1 or claim 2, wherein: the support member is a knuckle that is rotatably supported on the suspension arm; a caliper that supports a brake pad to be brought into contact with the brake rotor and forms a gap between itself and the knuckle is supported on the knuckle; and the brake rotor and the discharge opening face each other across the gap.

In the brake cooling structure in a vehicle of claim 4, air discharged through the discharge opening of the duct can be supplied to the brake rotor of the wheel using the gap formed between the knuckle and the caliper.

The brake cooling structure according to claim 5 is the brake cooling structure of claim 1 or claim 2, wherein a lower end surface of the duct is located below an under-cover provided in the vehicle, and is located at the same position in an up-down direction as a lower end surface of the suspension arm or above the lower end surface of the suspension arm.

In the brake cooling structure in a vehicle of claim 5, the lower end surface of the duct located below the under-cover is located at the same position in the up-down direction as the lower end surface of the suspension arm or above the lower end surface of the suspension arm. Thus, the area of a portion of the duct that is located below the under-cover is small as seen in a front view. Therefore, air resistance occurring due to the duct while the vehicle is traveling is less likely to become high.

The brake cooling structure in a vehicle according to the present disclosure has the excellent advantage of being able to effectively cool the brake rotor of the wheel using air discharged through the discharge opening of the duct.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a bottom view showing a front part of a vehicle to which a brake cooling structure according to an embodiment is applied, with ducts and one of front wheels omitted;

FIG. 2 is a perspective view of the brake cooling structure;

FIG. 3 is a perspective view of the brake cooling structure as seen from a direction different from that of FIG. 2;

FIG. 4 is a front view of the brake cooling structure;

FIG. 5 is a sectional view of a duct of the brake cooling structure taken along the arrowed line 5-5 of FIG. 4; and

FIG. 6 is a schematic side view of a gap among a brake rotor, a knuckle, and a caliper.

### DETAILED DESCRIPTION OF EMBODIMENTS

An embodiment of a brake cooling structure in a vehicle according to the present disclosure will be described below with reference to the accompanying drawings. The arrows FR, LH, and UP shown in the drawings as appropriate respectively indicate a vehicle front side that is a front side in a vehicle front-rear direction, a vehicle left side that is a left side in a vehicle left-right direction, and a vehicle upper side that is an upper side in a vehicle up-down direction. The front-rear direction, the left-right direction, and the up-down direction in the following description represent the vehicle front-rear direction, the vehicle left-right direction, and the vehicle up-down direction, respectively.

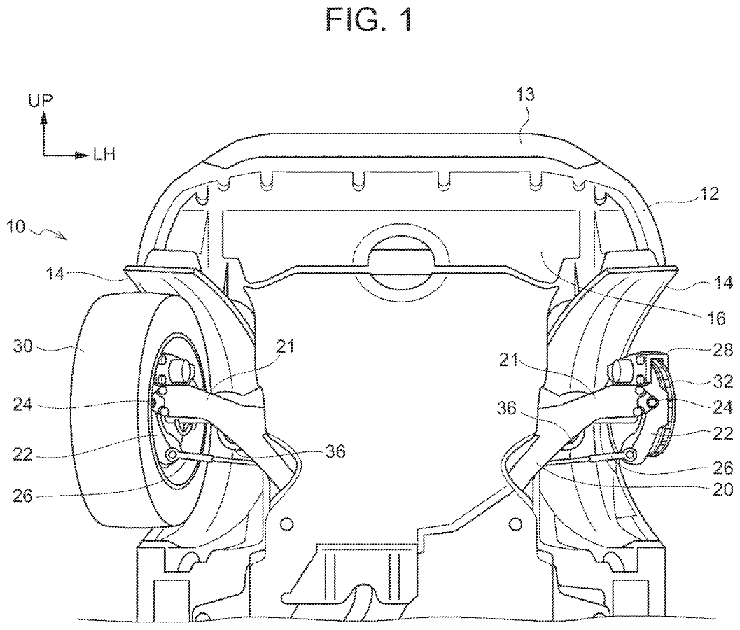

As shown in FIG. 1, a pair of left and right wheel houses 14 is provided in a front part of a vehicle body 12 of a vehicle 10 to which the brake cooling structure of the embodiment is applied. The vehicle body 12 further includes an under-cover 16 that constitutes a lower surface thereof.

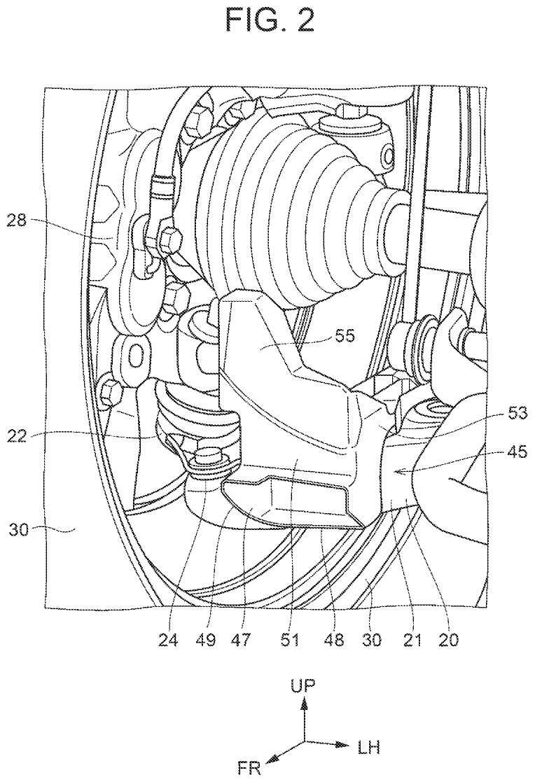

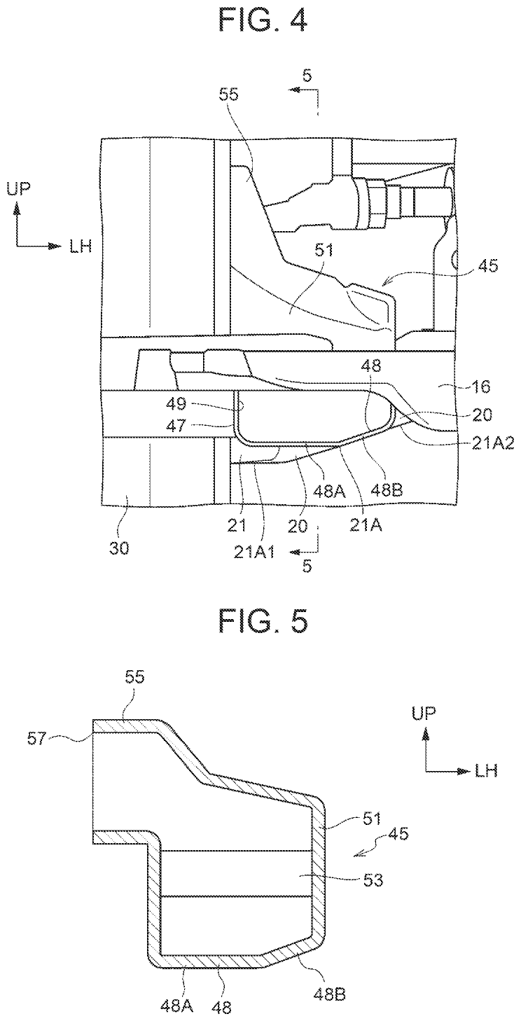

The vehicle 10 includes a suspension arm (lower arm) 20 of which a central portion in a longitudinal direction is disposed on an upper side of the under-cover 16 and which extends in the left-right direction. The central portion of the suspension arm 20 is swingably supported on part of the vehicle body 12. As shown in FIG. 1, left and right end portions 21 of the suspension arm 20 are located in spaces formed by the left and right wheel houses 14. Further, as shown in FIG. 4, a lower end surface 21A of each of the left and right end portions 21 has a first surface 21A1 that is parallel to the left-right direction as seen in a front view, and a second surface 21A2 that extends from an inner end portion of the first surface 21A1 toward the central portion of the suspension arm 20 and is inclined relative to the left-right direction as seen in a front view. The lower end surfaces 21A of the left and right end portions 21 are located below lower end surfaces of left and right end portions of the under-cover 16. As shown in FIG. 1 and FIG. 2, a lower end portion of a knuckle (support member) 22 is rotatably supported on each of the left and right end portions 21 through a ball joint 24. A tie rod 26 extending from a steering device (not shown) provided in the vehicle 10 is connected to the knuckle 22.

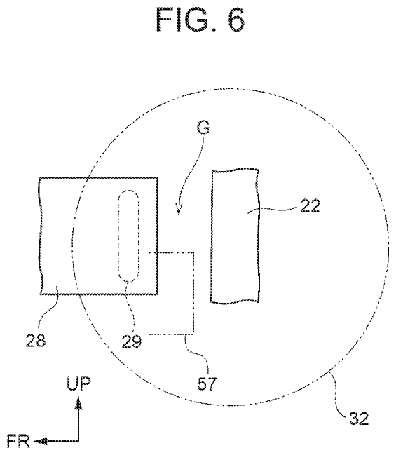

An axle hub that supports a front wheel (wheel) 30 penetrates the knuckle 22 in the left-right direction. A caliper 28 is fixed on the knuckle 22. The caliper 28 has a wheel cylinder into which a working fluid is introduced, and supports a brake pad 29 (sec FIG. 6) that is driven by a fluid pressure of the working fluid supplied to the wheel cylinder. A brake rotor 32 facing the brake pad 29 is fixed on the front wheel 30. When a brake pedal (not shown) is stepped on by a driver, the working fluid is supplied to the wheel cylinder, so that the brake pad 29 is pressed against the brake rotor 32 of the front wheel 30 and a braking force is generated. When the braking force is generated, friction heat is generated between the brake pad 29 and the brake rotor 32.

The vehicle 10 further includes a pair of left and right shock absorbers 36 (see FIG. 1). A coil spring (not shown) is provided on an outer circumferential side of cache shock absorber 36. A lower end portion of a housing of the shock absorber 36 that constitutes an external form thereof is coupled to the knuckle 22 through a bracket. A piston rod protruding upward from the housing of the shock absorber 36 is mounted on the vehicle body 12 through an upper support (not shown). A line connecting a mounting center point of the shock absorber 36 in the upper support and the ball joint 24 to each other is a king pin axis. Thus, the suspension of this embodiment is of a strut type.

A duct 45 is provided at each of the left and right end portions 21 of the suspension arm 20. The left and right ducts 45 are symmetrical in the left-right direction. Therefore, only the duct 45 on the right side will be described below.

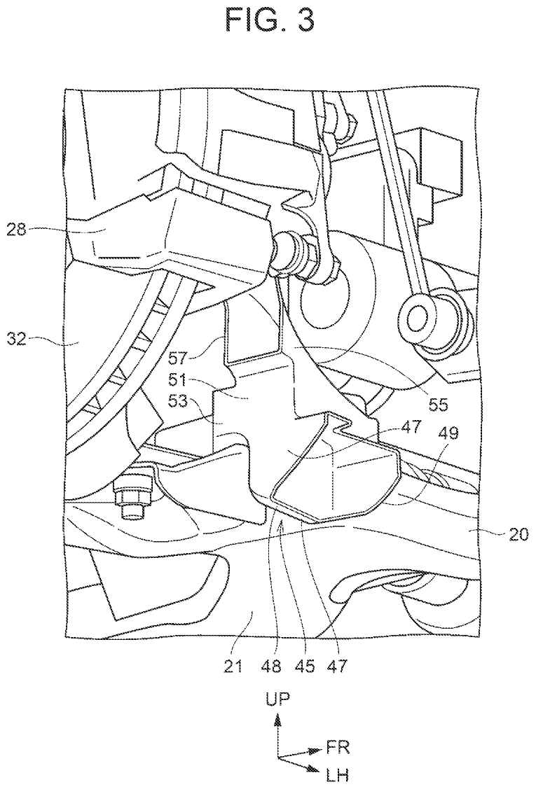

The duct 45 of this embodiment is an integrally molded part made of resin. However, the material of the duct 45 is not limited to resin. For example, the duct 45 may be made of metal. The duct 45 has an introduction part 47 constituting a lower end portion of the duct 45, an intermediate part 51 extending upward from a rear portion of the introduction part 47, a rearward protruding part 53 extending rearward from a rear portion of the intermediate part 51, and a discharge part 55 constituting an upper end portion of the duct 45. As shown in FIG. 2, FIG. 4, and FIG. 5, a front shape of the introduction part 47 is a substantially rectangular shape. A bottom plate portion 48 of the introduction part 47 is formed by a first constituent part 48A and a second constituent part 48B. The first 20 constituent part 48A is parallel to the left-right direction as seen in a front view. The second constituent part 48B extends from an inner end portion of the first constituent part 48A toward the central portion of the suspension arm 20 and is inclined relative to the left-right direction as seen in a front view. Further, an introduction opening 49 is formed in a front end surface of the introduction part 47. As shown in FIG. 2 and FIG. 3, the rearward 25 protruding part 53 is located rearward of and above the introduction part 47. A discharge opening 57 is formed in a right end surface of the discharge part 55. The duct 45 is a hollow structure. That is, one end of an internal space of the duct 45 is the introduction opening 49 and the other end of the internal space is the discharge opening 57. The area of the introduction opening 49 as seen in a front view is larger than the area of the discharge 30 opening 57 as seen in a side view.

As shown in FIG. 2 and FIG. 3, a lower surface of the rearward protruding part 53 is placed on an upper surface of the end portion 21 of the suspension arm 20, and a rear surface of the introduction part 47 faces a front surface of the end portion 21 while forming a gap between itself and the front surface. Further, as shown in FIG. 4, a portion of the introduction opening 49 except for an upper end portion is located below the lower end surface of the under-cover 16 as seen in a front view. Moreover, as shown in FIG. 4, a lower end surface of the second constituent part 48B substantially overlaps the second surface 21A2 of the end portion 21 of the suspension arm 20 in the front-rear direction as seen in a front view. That is, the position of the lower end surface of the second constituent part 48B in the up-down direction is substantially the same as that of the second surface 21A2 of the end portion 21 as seen in a front view. Furthermore, a portion of the duct 45 other than the second constituent part 48B is located above the lower end surface 21A of the end portion 21 as seen in a front view. In this state, the rearward protruding part 53 is fixed on the end portion 21. The means for fixing the rearward protruding part 53 to the end portion 21 may be any means. For example, a weld nut that is fixed on an inner part of the end portion 21 and a bolt that penetrates a bottom plate of the rearward protruding part 53 in the up-down direction and is screwed into the weld nut may be used as the fixing means.

Further, as shown in FIG. 2, FIG. 3, and FIG. 6, when the side of the front wheel 30 is seen from the side of a central portion of the vehicle 10 in the width direction, the discharge opening 57 of each duct 45 faces a gap G formed between part of the corresponding knuckle 22 and a rear end portion of the caliper 28 in the left-right direction.

In other words, the discharge opening 57 of each duct 45 faces part of the brake rotor 32 across the gap G.

### Workings and Advantages

Next, the workings and advantages of the embodiment will be described.

When the brake pedal is stepped on while the vehicle 10 is traveling, friction heat occurs between the brake pad 29 and the brake rotor 32. Thus, as the brake pad 29 is pressed against the brake rotor 32, the brake rotor 32 reaches a high temperature.

When the vehicle 10 travels forward, air present in front of the vehicle 10 acts as travel wind and flows into a clearance between the under-cover 16 and the road surface, and part of the travel wind flows into the introduction parts 47 of the left and right ducts 45. This travel wind flows upward through the internal space of each duct 45 and is discharged to the outside through the discharge opening 57. The air discharged through the discharge opening 57 passes through the opposite gap G and is supplied to the brake rotor 32.

Here, a comparative example in which a duct (not shown) is provided on a front bumper 13 (see FIG. 1) provided at a front end portion of the vehicle body 12 will be assumed. In this comparative example, the distance from the discharge opening provided at a rear end portion of the duct to the brake rotor 32 is long. By contrast, when the duct 45 is fixed on the end portion 21 of the suspension arm 20 as in this embodiment, the distance from the discharge opening 57 of the duct 45 to the brake rotor 32 of the corresponding front wheel 30 is short. Therefore, the brake rotor 32 of the front wheel 30 can be effectively cooled using air discharged through the discharge opening 57 of the duct 45.

Further, as shown in FIG. 4, at least part of the introduction opening 49 of the duct 45 is located below the under-cover 16. Therefore, when the vehicle 10 travels forward, travel wind is reliably introduced into the introduction opening 49.

Further, the area of the introduction opening 49 of the duct 45 is larger than the area of the discharge opening 57. Thus, the travel wind can be easily guided to the introduction opening 49. Moreover, air can be supplied from the discharge opening 57 to the brake rotor 32 under high pressure, so that the air supplied from the discharge opening 57 to the brake rotor 32 has a high cooling effect on the brake rotor 32.

Further, the position in the up-down direction of the lower end surface of the second constituent part 48B of the bottom plate portion 48 of the duct 45 located below the under-cover 16 is substantially the same as that of the lower end surface 21A of the end portion 21, and the portion of the duct 45 other than the second constituent part 48B is located above the lower end surface 21A. Thus, the area of the portion of the duct 45 that is located below the under-cover 16 is small as seen in a front view. Therefore, air resistance occurring due to the duct 45 while the vehicle 10 is traveling is less likely to become high.

Further, the left and right knuckles 22 rotate relative to the suspension arm 20 around the king pin axis. Moreover, as each knuckle 22 rotates, the position of the brake rotor 32 relative to the duct 45 as well as the shape of the gap G and the position of the gap G relative to the duct 45 change. However, since each duct 45 of this embodiment is provided at the end portion 21 of the suspension arm 20, the distance from the king pin axis to the duct 45 is short. Accordingly, the amount of change in the position of the brake rotor 32 relative to the duct 45, the amount of change in the shape of the gap G, and the amount of change in the position of the gap G relative to the duct 45 when the knuckle 22 rotates are small. That is, these amounts of change are smaller than the amounts of change in the above-described comparative example. Therefore, even when the knuckle 22 rotates, the discharge opening 57 and the gap G can be kept facing each other so as to supply the air discharged through the discharge opening 57 to the brake rotor 32 through the gap G.

While the brake cooling structure in a vehicle according to the embodiment has been described above, design changes can be made to this brake cooling structure in a vehicle as appropriate within such a range that no departure is made from the gist of the present disclosure.

For example, the duct 45 may be provided on a suspension arm on a rear wheel side, and a brake rotor of a rear wheel may be cooled by air discharged through the discharge opening 57 of this duct 45.

The entire introduction opening 49 may be located below the lower end surface of the under-cover 16 as seen in a front view.

The entire ducts 45 may be located above the lower end surfaces 21A of the left and right end portions 21 as seen in a front view.

The type of the suspension is not limited to the strut type. Whatever the type of the suspension may be, the duct 45 can be provided on the suspension arm (at least either the lower arm or the upper arm).

What is claimed is:

1. A brake cooling structure in a vehicle, the brake cooling structure comprising a duct that is provided on a suspension arm provided in the vehicle, and has an introduction opening through which air is taken in from a front side and a discharge opening through which the air is discharged toward a brake rotor that is provided on a wheel connected to the suspension arm through a support member.

2. The brake cooling structure according to claim 1, wherein at least part of the introduction opening is located below an under-cover provided in the vehicle.

3. The brake cooling structure according to claim 1, wherein an area of the introduction opening is larger than an area of the discharge opening.

4. The brake cooling structure according to claim 1, wherein:
the support member is a knuckle that is rotatably supported on the suspension arm;
a caliper that supports a brake pad to be brought into contact with the brake rotor and forms a gap between itself and the knuckle is supported on the knuckle; and
the brake rotor and the discharge opening face each other across the gap.

5. The brake cooling structure according to claim 1, wherein a lower end surface of the duct is located below an under-cover provided in the vehicle, and is located at a same position in an up-down direction as a lower end surface of the suspension arm or above the lower end surface of the suspension arm.
